(19) United States
(12) Patent Application Publication
(10) Pub. No.: US 2024/0286724 A1
(43) Pub. Date: Aug. 29, 2024

(54) PADDLE ASSEMBLY

(71) Applicant: Kardi Holdings Pty Ltd, Mona Vale, New South Wales (AU)

(72) Inventor: Greg STIGTER, Mona Vale (AU)

(21) Appl. No.: 18/690,367

(22) PCT Filed: Sep. 12, 2022
(86) PCT No.: PCT/AU2022/051097

§ 371 Date: Mar. 8, 2024

(30) Foreign Application Priority Data
Sep. 10, 2021 (AU) 2021902942

(51) Int. Cl. B63H 16/04

(52) U.S. Cl. CPC B63H 16/04

(57) ABSTRACT

Paddle assembly (11) including a pair of shaft bodies (12, 14) extending between opposed ends (16, 18, 20, 22). A first end (16, 20) of each body (12, 14) is connectable to the first end (16, 20) of the other body (12, 14) to allow rotationally positioning the bodies (12, 14) relative to each other in two or more positions. A second end (18, 22) of each body carries a paddle blade (24, 25, 26, 124). The shaft bodies (12, 14) are shaped to be connectable to each other in a first configuration (28) to form a bow-shaped shaft (30), and connectable to each other in a second configuration (32) to form an S-shaped shaft (34).

### PRIORITY STATEMENT

The application is the U.S. National Stage entry of international patent application PCT/AU2022/051097, filed Sep. 12, 2022, which claims priority to Australian patent application AU2021902942, filed Sep. 10, 2021, both of which are incorporated herein by reference in their entireties for all purposes.

### TECHNICAL FIELD

The present disclosure relates, generally, to paddle assemblies for driving a vessel, such as a kayak or stand up paddleboard (SUP), across water, or to drive a board, such as a skateboard, longboard or snowboard, across land.

### BACKGROUND

Paddles include an elongate shaft extending between a pair of paddle blades, a single blade and handle, or a foot and a handle. Paddles are used in a range of water sports to manually drive a vessel across water, as well as to drive a board across land. Paddling can be a strenuous activity for a user which may cause the user to become fatigued over time. User fatigue can be exacerbated when paddling a vessel through shallow water where a user may need to push off the ground, typically being mud or sand. This can hinder user satisfaction and/or user performance, such as affecting speed, acceleration and maximum distance travelled, and can be dangerous if the user finds themselves in a compromising position, such as capsizing or crashing in a remote location, after which the user may be too fatigued from paddling to resolve the danger effectively.

When paddling a SUP or kayak, the user's effort is directed towards using the fluid resistance of water during each stroke of a paddle to propel the vessel through the water, and overcoming fluid shear resistance to raise the paddle out of the water to then plunge the paddle into the water for the next stroke. When kayaking, the user's also must rotate a shaft of the paddle to correctly position the paddle for plunging into the water for the next stroke. When paddling a ground-dwelling board, such as a skateboard, longboard or snowboard, the user's effort is directed towards using the frictional resistance of a ground surface, including ice or snow, during each stroke of the paddle to propel the board across the ground.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

In an aspect of the present disclosure, there is provided a paddle assembly including: a pair of shaft bodies, each shaft body extending between opposed ends, a first end of each body being releasably connectable to the first end of the other body to allow rotationally positioning the bodies relative to each other in two positions, and a second end of each shaft body carrying a paddle blade, the shaft bodies being shaped to be connectable to each other in a first configuration to form a bow-shaped shaft, and connectable to each other in a second configuration to form an S-shaped shaft, wherein, in the first configuration, the shaft bodies are connected to each other such that the second end of each shaft body and each paddle blade is angled towards a first notional plane extending along a side of the paddle assembly, and wherein, in the second configuration, the shaft bodies are connected to each other such that the second end of one shaft body and the associated paddle blade is angled towards the first notional plane, and the second end of the other shaft body and the associated paddle blade is angled towards a second notional plane arranged parallel to and spaced from the first notional plane to extend along an opposed side of the paddle assembly.

Each shaft body may be shaped such that each end of the body defines an axis, and wherein the axis of the first end is arranged non-parallel to the axis of the second end. Each shaft body may define at least one bend between the ends to arrange the axes at a non-zero angle to each other. Each shaft body may define at least one curve between the ends to arrange the axes at a non-zero angle to each other. Each shaft body may be shaped such that the axes are arranged at an angle between about 3 and 7 degrees to each other.

At least a portion of each shaft body may be resiliently deformable. The first end of each shaft body may be configured to releasably engage the other body to allow rotationally locking the bodies in the two or more positions. The first end of one of the shaft bodies may carry at least one depressible pin, and the first end of the other shaft body may define an annular array of apertures, each aperture dimensioned to receive one of the pins, wherein arranging the, or each, pin in respective apertures engages the bodies.

Each paddle blade may include at least one of a buoyant material portion and a hollow shell. Each paddle blade may define a convex face arranged to be driven into the water, in use, The convex face may be shaped to decrease flutter of the paddle assembly in use. Each convex face may include a pair of oppositely curved portions. The oppositely curved portions may meet at a bridging portion, which may define an edge, thereby being shaped to cause water to flow past the blade in a lateral direction, in use. Each paddle blade may define a substantially V-shaped end for pushing against a surface. Each paddle blade may include a base surface spaced from and adjacent the V-shaped end.

The assembly may also include a pair of gripping portions, each gripping portion shaped to be manually grasped and arranged at the second end of one of the shaft bodies. Each gripping portion may be integrally formed with the associated paddle blade. The handle portion of the blade and/or the shaft body may be a flared portion. Each paddle blade may define opposed sides, at least a portion of each side is resiliently deformable.

Each paddle blade may be configured to be substantially buoyant such that, in use, when the paddle assembly is positioned in a vertically upright position so that one of the paddle blades is submerged in a body of water, approximately one-third of the submerged blade is supported above the body of water.

An end of at least one of the shaft bodies may be connectable to a handle. The shaft bodies may be significantly resiliently deformable such that, in use, the shaft bodies are connectable and deformable in the first configuration to form the bow-shaped shaft, and connectable and deformable in the second configuration to form the S-shaped shaft.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure will now be described by way of example only with reference to the accompanying drawings in which:

FIG. 1 shows a side view of an embodiment of a paddle assembly including a pair of shaft bodies connected in a first configuration to form a bow-shaped shaft of a double-ended paddle;

FIG. 2 shows a side view of the paddle assembly shown in FIG. 1, with the pair of shaft bodies connected in a second configuration to form an S-shaped shaft of a double-ended paddle;

FIG. 3 shows a side view of one of the shaft bodies shown in FIGS. 1 and 2 in a third configuration to form a shaft of a single-ended paddle;

FIG. 4 shows a perspective detailed view of a connector mechanism for connecting the shaft bodies shown in FIGS. 1 and 2;

FIG. 5 shows a perspective rear view of a first embodiment of a paddle blade connectable to one end of at least one of the bodies shown in FIGS. 1 and 2;

FIGS. 6a-6c show schematic cross sections at three respective points on the paddle blade shown in FIG. 5;

FIG. 7 shows a top view of a second embodiment of a paddle blade connectable to one end of at least one of the bodies shown in FIGS. 1 and 2;

FIGS. 8a-8c show schematic cross sections at three respective points on the paddle blade shown in FIG. 7;

FIG. 9 shows a schematic cross section of a third embodiment of a paddle blade;

FIG. 10 shows a top view of another embodiment of a paddle assembly including a fourth embodiment of a paddle blade;

FIG. 11 shows a side view of another embodiment of a paddle assembly for an alternative single-ended paddle; and

FIG. 12 shows a schematic side view of an embodiment of a tool assembly.

### DESCRIPTION OF EMBODIMENTS

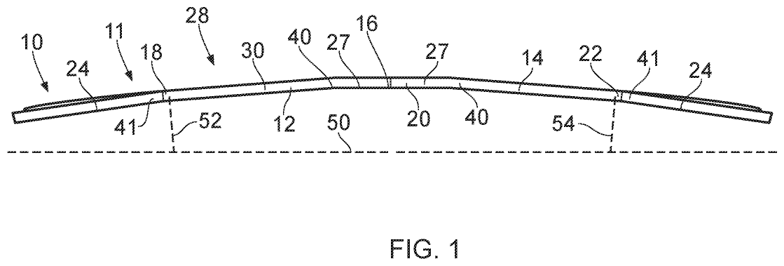

In the drawings, reference numeral 10 generally designates a shaft assembly 10. The shaft assembly 10 is suitable for forming a shaft, which may be part of a handle, of a paddle, such as is used to manually drive a vessel carrying a user through water, or a board carrying a user across land. The shaft assembly 10 is described throughout this specification configured as a paddle assembly 11, 201 (FIGS. 1-11) carrying a pair of paddle blades 24, 25, 26, 124. The shaft assembly is also suitable for forming a shaft, which may be part of a handle, of a hand tool used for manual labour, such as digging or cleaning, thereby forming a tool assembly 301 (FIG. 12).

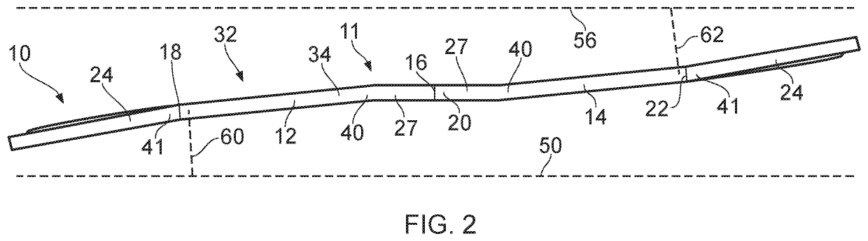

The paddle assembly 11 includes a pair of shaft bodies 12, 14. Each shaft body 12, 14 extends between opposed ends 16, 18, 20, 22. A first end 16, 20 of each body 12, 14 is connectable to the first end 16, 20 of the other body 12, 14 to allow rotationally positioning the bodies 12, 14 relative to each other in two or more positions. A second end 18, 22 of each body carries a paddle blade 24, 25, 26, 124. The shaft bodies 12, 14 are shaped to be connectable to each other in a first configuration 28 to form a bow-shaped shaft 30 (FIG. 1), and connectable to each other in a second configuration 32 to form an S-shaped shaft 34 (FIG. 2). In the first configuration 28, the shaft bodies 12, 14 are connected to each other such that the second end 18, 22 of each shaft body 12, 14 and each paddle blade 24, 25, 26, 124 is angled towards a first notional plane 50 extending along a side of the paddle assembly 11. In the second configuration 32, the shaft bodies 12, 14 are connected to each other such that the second end 18, 22 of one shaft body 12, 14 and the associated paddle blade 24, 25, 26, 124 is angled towards the first notional plane 50, and the second end 18, 22 of the other shaft body 12, 14 and the associated paddle blade 24, 25, 26, 124 is angled towards a second notional plane 56 arranged parallel to and spaced from the first notional plane 50 to extend along an opposed side of the paddle assembly 11.

It will be understood that “bow-shaped shaft” refers to any shaft that resembles the shape of a bow, being arced or arched, and may be formed from one or more linear and/or non-linear (curved) portions. For example, where the shaft bodies 12, 14 include non-linear portions, all points defined by the shaft 30 would have the same sign of concavity, i.e. the concavity of all points on the shaft are positive or negative (less than zero or more than zero).

In the embodiment shown in FIG. 1, the shaft bodies 12, 14 include linear portions so that the shaft 30 has portions with gradients of opposite signs, i.e. one portion has a negative gradient (less than zero) and one portion has a positive gradient (greater than 0). In this example, the second ends 18, 22 which carry the paddle blade 24, 25, 26, 124 are angled or facing towards the first notional plane 50 as shown by perpendicular lines 52, 54. In this embodiment, the second ends 18, 22 arranged to be coplanar. In this embodiment, the paddle blades 24, 25, 26, 124 are connected to the second ends 18, 22 of the shaft bodies 12, 14 such that the paddle blades 24, 25, 26, 124 are also angled or facing towards the first notional plane 50. It will be appreciated that, in other embodiments (not illustrated), the bow-shaped shaft 30 may not be symmetrical, as shown in FIG. 1, and that the shaft 30 is considered a bow-shaped shaft 30 for a range of ±90 degrees of rotational positioning of the bodies 12, 14 relative to each other with reference to the rotational position shown in FIG. 1.

It will be understood that “S-shaped shaft” refers to a shaft that resembles the shape of an “S”, or otherwise defines a pair of oppositely directed arcs or curves. The shaft bodies 12, 14 may include one or more linear and/or non-linear portions to form the S-shaped shaft 34 and may form an elongated S-shape, such as shown in FIG. 2. In other embodiments (not illustrated), shaft bodies 12, 14 are shaped to define a pronounced S-shape with a high degree of curvature and/or bending. For example, where the shaft bodies 12, 14 include non-linear portions, the shaft 34 would include a point or portion of inflexion at which there is no or zero concavity, and portions of the shaft adjoining the point or portion of inflexion would have concavities of opposing signs. That is, a portion of the shaft 34 adjoining the point or portion of zero concavity has a positive concavity (i.e. greater than zero) and another portion of the shaft 34 adjoining the point or portion of zero concavity has a negative concavity (i.e. less than zero).

In the embodiment shown in FIG. 2 where the shaft bodies 12, 14 include linear portions, the second ends 18, 22 of the shaft 34 have the same sign gradient, i.e. both having negative gradients or both having positive gradients. In this example, the second ends 18, 22 which carry the paddle blade 24, 25, 26, 124 are each angled or facing towards one of two substantially parallel, spaced planes 50, 56 extending along opposed sides of the paddle assembly 11, as shown by perpendicular lines 60, 62. It will be appreciated that, in other embodiments (not illustrated), the S-shaped shaft 34 may not be symmetrical as shown in FIG. 2, and that the shaft 34 is considered an S-shaped shaft 34 for a range of ±90 degrees of rotational positioning of the bodies 12, 14 relative to each other with reference to the rotational position shown in FIG. 2.

FIGS. 1 to 3 show the paddle assembly 11 configured to form the shaft of three different paddles, each including at least one paddle blade 24, 25, 26. In the illustrated embodiments of FIGS. 1 and 2, the shaft bodies 12, 14 each have a linear portion 27 arranged to form a central portion of the shafts 30, 34 arranged between a pair of the blades 24, 25, 26.

In some embodiments (not illustrated), the shaft assembly 10 includes a blade or foot configured for gripping the ground (not shown), and the second end 18, 22 of at least one of the shaft bodies 12, 14 is connectable to the blade or foot to form a paddle for a longboard or skateboard. In other embodiments (not illustrated), the shaft assembly 10 includes a snow blade or snow foot configured for gripping loose snow or ice and the second end 18, 22 of at least one of the shaft bodies 12, 14 is connectable to the snow blade/foot to form a paddle for a snowboard. The snow blade/foot may include a conventional pole and basket arrangement, or may include a ball-like structure defining a plurality of ribs or flaps extending from a base surface and arranged to enhance gripping snow or ice, such as arranged in a chevron configuration. It will be understood that the blade or foot, or snow blade or snow foot, may be releasably connectable to the second end 18, 22 of at least one of the shaft bodies 12, 14.

Each shaft body 12, 14 is shaped such that each end 16, 18, 20, 22 defines an axis 36, 38, wherein the axis 36, 38 of the first end 16, 20 is arranged non-parallel to the axis 36, 38 of the second end 18, 22. In the illustrated embodiments, each shaft body 12, 14 defines a kink or bend 40 between the ends 16, 18, 20, 22 to arrange the axes 36, 38 at a non-zero angle to each other. Each shaft body 12, 14 is shaped such that the axes 36, 38 are arranged at an angle between about 1 and 20 degrees to each other, particularly between about 3 and 7 degrees to each other. It will be understood that the bend 40 may be between 1 and 20 degrees to arrange the axes 36, 38 at a corresponding angle. It will also be understood that the shaft bodies 12, 14 may define a plurality of kinks or bends 40, each bend being between 1 and 7 degrees, and that the angular separations of each of the plurality of bends 40 may be summed to arrange the axes 36, 38 at a non-zero angle to each other.

In some embodiments, the paddle blade 24, 26 is connectable to the second end 18, 22 of the body 12, 14 such that an axis 39 defined by the paddle blade 24, 26 is non-parallel to the axis 38 defined by the second end 18, 22 of the body 12, 14. This non-parallel arrangement of the blade 24, 26 relative to the second end 18, 22 creates an additional kink or bend 41 to arrange the axes 38, 39 of the second end 18, 22 of the body 12, 14 and the paddle blade 24, 26, respectively, at an angle between about 1 and 20 degrees to each other, particularly between about 3 and 7 degrees to each other. In some embodiments, the axis 39 of the paddle blade 24, 26 and the axis 36 of the first end 16, 20 of the body 12, 14 are arranged at an angle between about 2 and 40 degrees to each other, particularly between about 6 and 14 degrees to each other. It will be understood that in some embodiments, the additional kink or bend 41 is defined by the shaft body 12, 14, and in other embodiments, defined by a portion of the paddle blade 24, 25, 26, 124, such as the portion adjacent the second end 18, 22 of the shaft body 12, 14. It will also be understood that the paddle blade 24, 26 may be releasably connectable to the second end 18, 22 of at least one of the shaft bodies 12, 14.

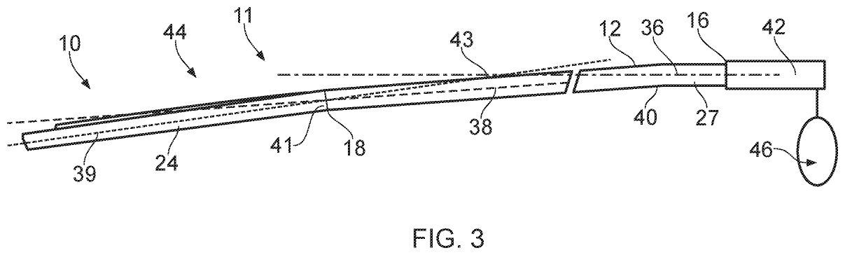

In some embodiments and as best shown in FIG. 3, the axis 36 of the first end 16 of the shaft body 12, 14 and the axis 39 of the paddle blade 24, 26, intersect at a point 43 which is approximately two-fifths along the total length of the blade 24, 26 and shaft body 12, 14. As shown in FIG. 3, in the illustrated embodiment, the point of intersection 43 is arranged on the shaft body 12, though it will be understood that the blade 24, 26 and/or shaft body 12, 14 may be configured such that the point of intersection 43 is spaced from the shaft body 12, 14. It will also be understood that the point of intersection 43 may be positioned at another point along the horizontal component of the length of the blade 24, 26 and shaft body 12, 14.

In some embodiments (not illustrated), each shaft body 12, 14 may define at least one curve, instead of, or in addition to, the bend 40, between the ends 16, 18, 20, 22 to arrange the axes 36, 38 at a non-zero angle to each other. For example, in some embodiments, one or both of the shaft bodies 12, 14 defines a continuous curve between the ends 16, 18, 20, 22.

In some embodiments, at least a portion of each shaft body 12, 14 is resiliently deformable, and in other embodiment, significantly resiliently deformable to readily allow manual deformation during use. The resilient deformability of the shaft bodies 12, 14 allows flexing the shaft 30, 34 in use when propelling a vessel or board. The flexing during each stroke of the paddle assembly 11 stores elastic potential energy in the shaft 30, 34 which is releasable in the form of work to assist with paddling as the shaft 30, 34 returns to its original shape. It will be understood that the arrangement of the axes 36, 38 at a non-zero angle to each other via the kink or bend 40, the additional kink or bend 41, and/or the at least one curve between the ends 16, 18, 20, 22, increases the distance that the shaft 30, 34 flexes during each stroke, thereby increasing the amount of elastic potential energy stored in the shaft 30, 34 that is releasable in the form of work in an operatively rearward direction in use, thereby assisting with paddling as the shaft 30, 34 returns to its original shape.

It will be appreciated that having both the second ends 18, 22 of the shaft bodies 12, 14 and the paddle blades 24, 25, 26, 124 being angled towards the same first notional plane 50 in the first configuration 28 allows the user to harness this elastic potential energy as the user drives the paddle assembly 11 through the water, since the direction of the user's force causes the shaft 30, 34 to flex in the same direction that the paddle blades 24, 25, 26, 124 are facing in use, i.e. towards the first notional plane 50. This allows the elastic potential energy to be released in the form of work in the direction of the user's stroke which is towards first notional plane 50 to assist with paddling as the shaft 30, 34 returns to its original shape. It will also be appreciated that having the second end 18, 22 of one shaft body 12, 14 and the associated paddle blade 24, 25, 26, 124 angled towards the first notional plane 50, and the second end 18, 22 of the other shaft body 12, 14 and the associated paddle blade 24, 25, 26, 124 angled towards the second notional plane 56, allows each shaft body 12, 14 to flex in the same direction that the paddle blades 24, 25, 26, 124 are facing in use, i.e. towards either the first notional plane 50 or the second notional plane 56. This allows the elastic potential energy to be released in the form of work in the direction of the user's stroke which is towards either the first notional plane 50 or the second notional plane 56, depending on which of the shaft bodies 12, 14 are being used in that particular stroke, to assist with paddling as the shaft 30, 34 returns to its original shape.

In some embodiments, such as illustrated in FIG. 3, the first end 16, 20 of at least one of the shaft bodies 12, 14 is connectable to a handle 42. The handle 42 may include a wrist securing loop 46. In some embodiments, both shaft bodies 12, 14 can be connected to, or carry, a handle 42 in a third configuration 44 of the assembly 11 to allow a user to use the shaft bodies 12, 14 in separate hands, for example, to push off the ground, or to paddle with both arms simultaneously.

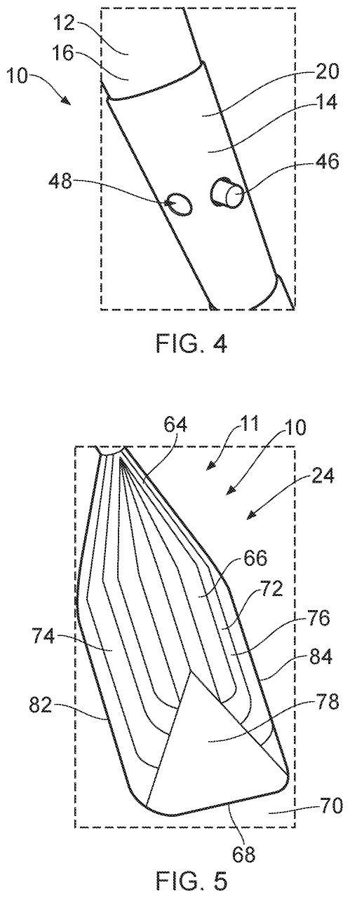

In the illustrated embodiments, the first end 16, 20 of each shaft body 12, 14 is configured to releasably engage the other body 12, 14 to allow rotationally locking the bodies 12, 14 in the two or more positions relative to each other. This may be achieved by a releasable locking mechanism, such as illustrated in FIG. 4, which shows at least one depressible pin 46 carried by the first end 16 of one of the shaft bodies 12, and the end 20 of the other shaft body 14 which defines an annular array of apertures 48, each aperture 48 dimensioned to receive one of the pins 46. In this embodiment, arranging the, or each, pin 46 in respective apertures 48 engages the bodies 12, 14. This allows securing the bodies 12, 14 together about the axis 38 at two positions, being zero degrees and 180 degrees.

It will be appreciated that, in other embodiments, the mechanism is configurable to allow rotationally locking the bodies 12, 14 together at other relative rotational positions, such as 90 degrees and 270 degrees. In this embodiment, the shaft bodies 12, 14 are not identical since the first end 20 of one of the bodies 14 is configured to receive the first end 16 of the other body 12 to allow the pin 46 to be received in one of the apertures 48. In some embodiments, the first end 16, 20 of each shaft body 12, 14 carries padding (not shown) for increased user comfort and grip, and it will be appreciated that the padding may be connectable to the first end 16 of the shaft body 12 via an aperture (not shown) configured to receive the pin 46, and may be connectable to the end 20 of the shaft body 14 via an adhesive, a fastener, an interference fit, or the like.

It will be appreciated that the shaft assembly 10 may include any suitable connecting means to allow rotationally positioning the bodies 12, 14 relative to each other in two or more positions. For example, in some embodiments the shaft bodies 12, 14 include complementary threaded connectors, and/or bayonet-type connectors. In other embodiments, additionally or alternatively, the shaft bodies carry one or more magnets. Other embodiments include a frictional engagement mechanism, such as forming a press-fit. It will be understood that where each shaft body 12, 14 includes a magnetic connector, the shaft bodies 12, 14 may be configured to be substantially identical. In some embodiments, the handle 42 is connectable to the first end 16, 20 of the shaft body 12, 14 using similar or the same connecting means as is provided to connect the shaft bodies 12, 14. In some embodiments, the paddle blade 24, 25, 26 and/or the blade or foot and/or the snow blade or snow foot, is/are connectable to the second end 18, 22 of at least one of the shaft bodies 12, 14 using similar or the same connecting means as is provided to connect the shaft bodies 12, 14.

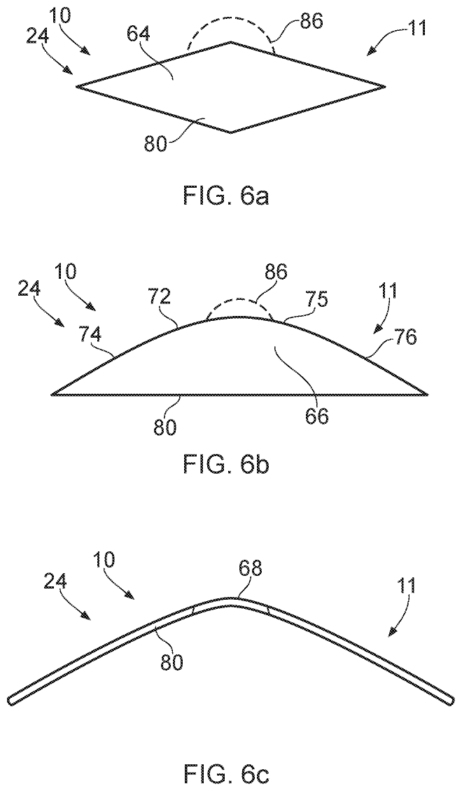

FIGS. 5 and 6a to 6c show an embodiment of the paddle blade 24 in isolation, the embodiment configured for pushing off or against a surface, such as a bed of a river or lake, when maneuvering a vessel. The blade 24 is shaped to define a convex front face 72 to enhance gliding through water, and a thickened rear portion 66 to enhance buoyancy and provide support when pushing against a surface.

FIGS. 6a to 6c illustrate three cross-sections of the blade 24. FIG. 6a illustrates a cross-section at or near the upper end of the blade 24, as illustrated in FIG. 5, where the blade 24 defines a diamond-shaped portion 64. FIG. 6b illustrates a cross-section mid-way along the blade 24, showing the convex face 72 and the thickened, rear portion 66. FIG. 6c illustrates a cross-section at or near the lower end of the blade 24 as illustrated in FIG. 5, showing a substantially V-shaped end 68.

The convex face 72 is shaped to direct water past the blade 24 in use. In this embodiment, the convex face 72 includes a pair of opposed substantially planar regions 74, 76 joined by an arched portion 75. The rear portion 66 defines an inclined base surface 78 spaced from and extending away from the V-shaped end 68, the surface 78 arranged to limit the distance the blade 24 can sink into the ground, such as into loose sand, in use. The V-shaped end 68 is arranged to extend away from the base surface 78 to define a thin edge shaped to enhance penetrating the ground to provide grip.

Best shown in FIG. 5, at least a portion of opposed sides of the blade 24 are configured to be resiliently deformable, in this embodiment being configured as wings 82, 84 extending from each side. Configuring the sides 82, 84 of the blade 24 in this way allows storing elastic potential energy during use which is releasable in the form of work to assist with paddling as the sides 82, 84 of the blade 24 move back to their original shape.

To enhance buoyancy of the blade 24, the blade 24 may include at least one of a buoyant material portion, such as polypropylene and the like, and a hollow shell. For example, in the illustrated embodiment, the rear portion 66 is formed from one or more of a foamed polymer and hollow structure. In some embodiments, the blade 24 includes a substantially rigid spine 86 extending longitudinally through the blade 24 to enhance structural integrity during use.

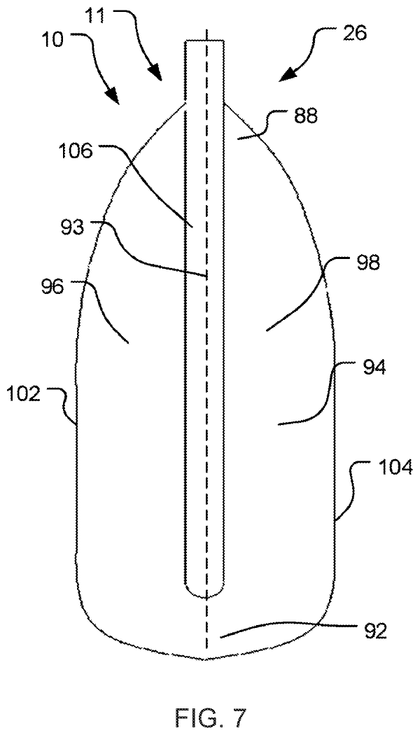

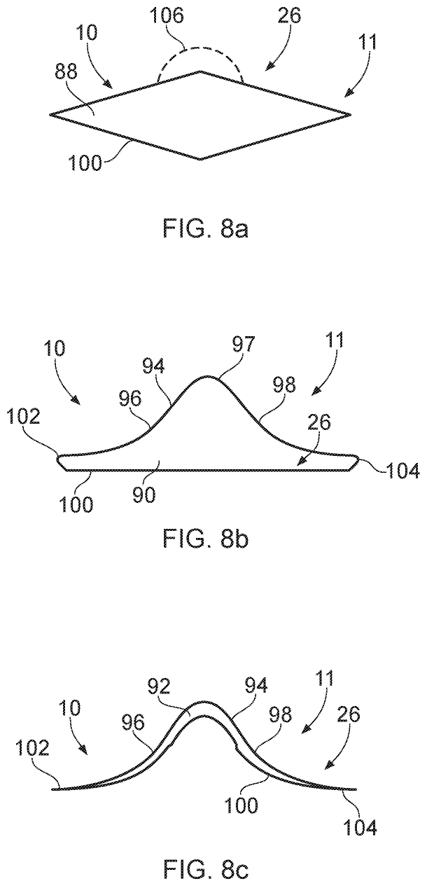

FIGS. 7 and 8a to 8c show an embodiment of the paddle blade 26 in isolation, the embodiment configured for enhanced speed and/or efficiency during paddling. The blade 26 is shaped to define a convex front face 94 to enhance gliding through water, and a thickened rear portion 90 to enhance buoyancy.

FIGS. 8a to 8c illustrate three cross-sections of the blade 26. FIG. 8a illustrates a cross-section at or near the upper end of the blade 26, as illustrated in FIG. 7, where the blade 26 defines a diamond-shaped portion 88. FIG. 8b illustrates a cross-section mid-way along the blade 26, showing the convex face 94 and the thickened, rear portion 90. FIG. 8c illustrates a cross-section at or near the lower end of the blade 26, showing a substantially V-shaped end 92.

The convex face 94 is shaped to direct water past the blade 26, in use, as the blade 26 is driven through the water by the user. In this embodiment, the convex face 94 includes a pair of oppositely curved portions 96, 98 joined by a bridging portion 97, in this embodiment defining an arch between the curved portions 96, 98. The curved portions 96, 98 are shaped to cause water to flow over the face 94, as it is driven through the water, in a direction substantially perpendicular to a longitudinal axis 93 of the blade 26, i.e. in a lateral direction. Configuring the blade 26 in this way to cause lateral water flow may enhance thrust generated by the paddle assembly 11, in use. The later flow of the water away from the sides of the blade 26 may interact with water located adjacent the sides to increase fluid resistance to the blade 26 travelling through the water. In this way, the shape of the curved portions 96, 98 can increase the effective width of the blade 26.

The rear portion 90 defines a base surface 100 spaced from and substantially parallel to the V-shaped end 92, the surface 100 arranged to limit the distance the blade 24 can sink into the ground, such as into loose sand, in use. The V-shaped end 92 is arranged to extend away from the base surface 100 to define a thin edge shaped to enhance penetrating the ground to provide grip.

Best shown in FIG. 8c, at least a portion of opposed sides of the blade 26 are configured to be resiliently deformable, in this embodiment being configured as wings 102, 104 extending from each side. Configuring the sides 102, 104 of the blade 24 in this way allows storing elastic potential energy during use which is releasable in the form of work to assist with paddling as the sides 102, 104 of the blade 24 move back to their original shape.

To enhance buoyancy of the blade 26, the blade 26 may include at least one of a buoyant material portion, such as polypropylene and the like, and a hollow shell. For example, in the illustrated embodiment, the rear portion 100 is formed from a foamed polymer. In this embodiment, the blade 26 includes a substantially rigid spine 106 extending longitudinally through the blade 26 to enhance structural integrity during use. In some embodiments, the blade 26 is substantially buoyant such that, when the paddle assembly 11 is supported or held in a vertically upright position in a body of water, for example, freshwater or seawater, approximately one-third of the blade 26 remains above the surface of the body of water.

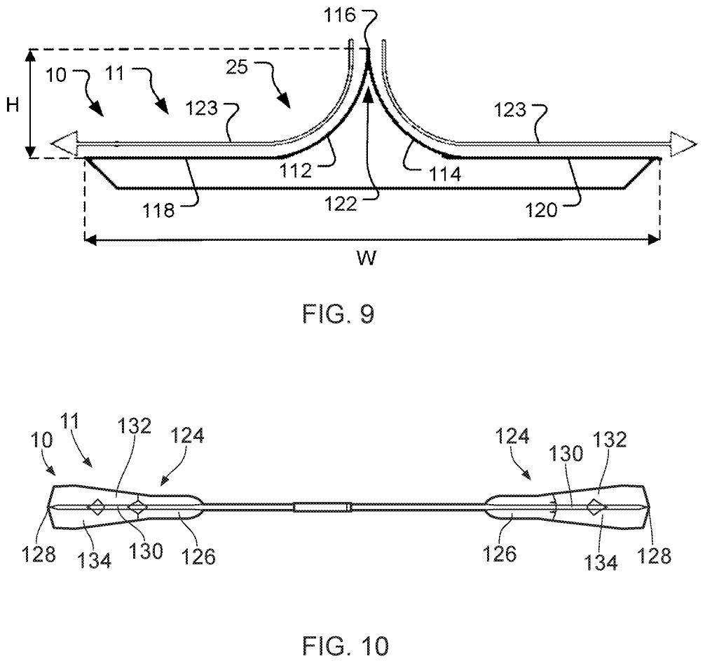

FIG. 9 illustrates a cross-section mid-way along the blade 25 in isolation. The blade 25 is shaped to define a convex front face 108 to increase fluid resistance when being driven through water, and a thickened rear portion 110 to enhance buoyancy. The convex face 108 is shaped to direct water past the blade 25 in use. In this embodiment, the convex face 108 includes a pair of oppositely curved portions 112, 114 joined by a bridging portion, in this embodiment forming a sharpened ride or edge 116, and a pair of substantially flat portions 118, 120 each joined to one of the curved portions 112, 114. The curved portions 112, 114 define a steep transition to meet the edge 116 to define an acute angle 122 between the curved portions 112, 114, thereby being shaped to cause water to flow in a lateral direction, i.e. along the substantially horizontal portions 118, 120 as shown by arrows 123, in use. This increased lateral water flow may increase fluid resistance opposing blade 25 movement and, as a result, increase thrust generated by the paddle assembly 11, in use.

FIG. 10 illustrates an alternative embodiment of a paddle blade 124 being shown as a part of the paddle assembly 11, with like reference numerals representing like features of the paddle assembly 11. The paddle blade 124 defines a gripping portion configured to be manually graspable, in the illustrated embodiment being shaped in the form of a flared portion 126 integrally formed with one of the paddle blades 26. The flared portion 126 may enhance the grip and comfort of the user by providing a comfortable stopping portion which the user's hand can bear against for support, thereby reducing the prevalence of the user's hand sliding off of the shaft 30, 34 and along the paddle blade 124, in use.

The paddle blade 124 also defines a V-shaped end 128, a spine 130 and wings 132, 134 arranged on either side of the spine 130. It will be understood that each of these features of the blade 124 may provide similar advantages as a similar feature of paddle blades 24, 25, 26. In some embodiments, the shaft bodies 12, 14 may instead include the gripping portion (not shown), such as being connected to or integrally with the shaft bodies 12, 14, to provide the same advantages of grip and comfort as discussed above with respect to the gripping portion of the blade 124. It will also be understood that the shaft bodies 12, 14 and the blades 124 may each include part of the gripping portion, for example, the shaft bodies 12, 14 may include part of the flared portion 126 and the blade 124 may include another part of the flared portion 126.

In some embodiments, the blade 24, 25, 26, 124 is configured to be substantially buoyant such that, in use, when the paddle assembly 11 is positioned or supported or held in a vertically upright position such that one of the paddle blades 24, 25, 26, 124 is in a body of water, for example, freshwater or seawater, approximately one-third of the blade 24, 25, 26, 124 is supported above the surface of the body of water. Configuring the blade 24, 25, 26, 124 in this way can enhance the user readily withdrawing the assembly 11 from water during paddle strokes, such as by causing the assembly 11 to rebound from being manually depressed into the water, in other words, causing the assembly 11 to bounce or pop out of the water.

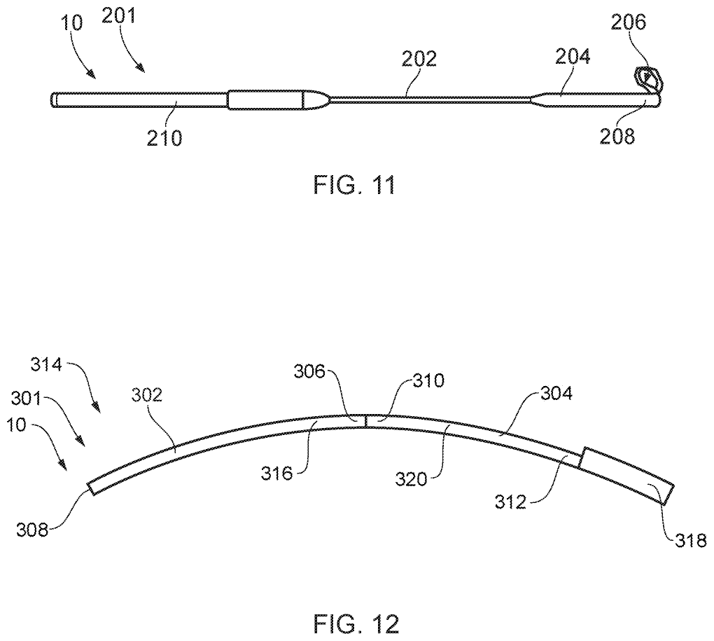

FIG. 11 shows another embodiment of the shaft assembly 10 configured as a shaft of an alternative paddle assembly 201. The paddle assembly 201 includes a shaft body 202 having an elongate handle 204. The handle 204 includes a wrist securing loop 206 attached at an end 208. The paddle assembly 201 further includes an elongate paddle blade 210 which is significantly resiliently deformable to allow storing a large elastic potential energy which is releasable in the form of work to assist with paddling as the paddle blade 210 moves back to its original shape. The paddle blade 210 is shaped to define a compact footprint to allow being steadily planted into a ground surface, such as sand or mud. At least a portion of the paddle blade 210 is formed from a buoyant material and/or includes a hollow shell.

The shaft body 202 is connectable to another shaft body (not shown), instead of the handle 204, by a connector mechanism, such as the mechanism described above with reference to the shaft assembly 10. The shaft body 202 has a portion that is, or is entirely, significantly resiliently deformable, thus when connected to another like shaft body 202, the shaft bodies 202 may be manually deformed during use to form the bow-shaped shaft and the S-shaped shaft transiently as a result of applied forces. The high degree of flex of the bodies 202 allows for use in paddling a kayak, SUP and/or longboarding.

FIG. 12 shows another embodiment of the shaft assembly 10 configured as a shaft of a tool assembly 301. The tool assembly 301 includes a pair of shaft bodies 302, 304, each shaft body 302, 304 extending between opposed ends 306, 308, 310, 312. One end 306, 310 of each body 302, 304 is releasably connectable to the one end 306, 310 of the other body 302, 304 to allow rotationally positioning the bodies 302, 304 relative to each other in two or more positions. The bodies 302, 304 are connectable in a first configuration 314 to form a bow-shaped shaft 316, and the shaft bodies 302, 304 are connectable in a second configuration to form an S-shaped shaft, in a similar manner to the paddle assembly 11.

The tool assembly 301 includes a tool head 318. An end 308, 312 of at least one of the shaft bodies 302, 304 is connectable to the tool head 318 to form a hand tool 320. One end 308, 312 of the bow-shaped shaft 316 is configurable to bear against the user, such as a shoulder, chest, torso, upper arm or back of the user, to provide an anchoring point or support during pushing and pulling motions exerted by the user on the shaft bodies 302, 304.

The tool head 318 is configurable for one or more of cutting, digging, raking, cleaning, and brushing. In various embodiments, the tool head 318 is, but is not limited to, a cutting blade, a shovel head, a spade head, a hoe head, a bristle formation such as a paint brush or broom head, or an absorbent body such as a mop head. This allows forming various hand tools 320 such as a trimmer, a shovel, a liquid applicator such as a paint brush, or a cleaning tool such as a mop. In some embodiments, at least one of the shaft bodies 302, 304 carries a connector mechanism (not illustrated) operable to releasably engage the tool head 318, which may allow interchanging between differently configured tool heads 318 to perform various tasks.

In use, the shaft bodies 12, 14 of the paddle assembly 11 may be connected at the first ends 16, 20 in the first configuration 28 to form the bow-shaped shaft 30. In the illustrated embodiment of FIG. 1, the bow-shaped shaft 30 is connected to a paddle blade 24, 26 at each second end 18, 22. In other embodiments, one blade 26 is substituted with the handle 42.

The bow-shaped shaft 30 is usable in SUP, kayak or longboard settings, though it has particular application to paddling a SUP. During use in this way, the user may grip the shaft 30 with two hands such that the shaft 30 is upright and bowed away from the user, plunge either blade 24, 26 into water in front of the user, and pull the blade 24, 26 through the water and towards the user to use the fluid resistance of the water and complete the stroke. The user then raises the paddle blade 24, 26 from the water to position the paddle assembly 11 for the next stroke. During the stroke, the shaft 30 flexes and stores elastic potential energy. This is then released as work to move the blade 24, 26 in the direction of the stroke, being towards the rear of the vessel. The configuration of the shaft 30 to provide this spring effect can enhance efficiency of the stroke. Where the shaft bodies 12, 14 are configured to be substantially resiliently deformable, this can increase the spring effect. The release of stored potential energy may also enhance withdrawing the paddle blade 24, 26 from the water, causing the blade 24, 26 to spring out of the water. Where the blade 24, 26 is configured to be substantially buoyant, this further enhances propelling the blade 24, 26 out of the water.

Alternatively, the shaft bodies 12, 14 of the paddle assembly 11 may be connected at the first ends 16, 20 in the second configuration 32 to form the S-shaped shaft 34. The S-shaped shaft 34 is connected to a paddle blade 24, 26 at each second end 18, 22.

The S-shaped shaft 34 is usable in SUP, kayak or longboard settings, though it has particular application to paddling a kayak or a kneeboard, such as a surf rescue board. During use in this way, the user may grip the shaft 34 with two hands such that the shaft is more diagonal than when in the standing position, plunges one of the blades 24, 26 into water in front of the user, pulls the blade 24, 26 through the water toward the user to use the fluid resistance of the water and complete the stroke, and raises the paddle blade 24, 26 from the water to position the other paddle blade 24, 26 for the next stroke. The user is also able to push the portion of the shaft 34 that is out of the water while pulling the portion of the shaft 34 that is in the water which can increase the force applied through the water and therefore propel the vessel faster than the use of a straight-shafted paddle. During the stroke, the shaft 34 flexes and stores elastic potential energy. This is then released as work to move the blade 24, 26 in the direction of the stroke, being towards the rear of the vessel. The configuration of the shaft 30 to provide this spring effect can enhance efficiency of the stroke. Where the shaft bodies 12, 14 are configured to be substantially resiliently deformable, this can increase the spring effect. The release of stored potential energy may also enhance withdrawing the paddle blade 24, 26 from the water, causing the blade 24, 26 to spring out of the water, which may also aid rotation of the shaft 34 in the user's hands such that the other blade 24, 26 is appropriately arranged for the next stroke. Where the blade 24, 26 is configured to be substantially buoyant, this further enhances propelling the blade 24, 26 out of the water.

Further alternatively, the first end 16, 20 of each shaft body 12, 14 may be connected to a respective handle 42 in the third configuration 44, as illustrated in FIG. 3. The second end 18, 22 of each shaft body 12, 14 is connected to a paddle blade 24, 26. These separate shaft bodies 12, 14 are widely usable in SUP, kayak or longboard settings (standing, sitting or kneeling) depending on an overall length of the handles 42 and the shaft bodies 12, 14. The user grips each of the handles 42 or shaft bodies 12, 14 with separate hands to allow paddling with both shaft bodies 12, 14 simultaneously or in an alternating fashion, with the shaft bodies 12, 14 being bowed towards the user.

The paddle assembly 201 may be used by connecting a pair of the shaft bodies 202 together, connecting the paddle blade 210 to one or both of the shaft bodies 202, and executing a paddling motion as described above. The user may instead connect one or both of the shaft bodies 202 to the handle 204 to allow using the shaft bodies 202 connected together or separately. It will be understood that one or both of the shaft bodies 202 may be releasably connectable to the handle 204 and/or the paddle blade 210.

The tool assembly 301 may be used by connecting the pair of the shaft bodies 302, 304 together, and connecting the tool head 318 to one or both of the shaft bodies 302, 304 to form the hand tool 320, such as one of the example tools described above. Additionally or alternatively, one or both of the shaft bodies 302, 304 are connectable to a handle, such as the handle 42 or the handle 204, to allow using the shaft bodies 302, 304 connected together or separately. It will be understood that one or both of the shaft bodies 302, 304 may be releasably connectable to the handle and/or the tool head 318.

The paddle assembly 11 includes the pair of shaft bodies 12, 14 which are releasably connectable in distinct first and second configurations 28, 32 to affect the geometry of the paddle shaft and, consequently, the function of the paddle assembly 11. This can mean that the paddle assembly 11 is readily configurable to be optimised for paddling a SUP, such as in the bow-shaped first configuration 28, or optimised for paddling a kayak, or kneeboard, such as in the S-shaped second configuration 32.

When the paddle assembly 11 is configured to have the bow-shaped shaft 30, the user may hold the shaft bodies 12, 14 at points which are closer to the user than the blades 24, 26 in use, and are closer to the user than they would be when using a straight-shafted paddle. The user is also able to reach further forward with the blade 24, 26 for the start of the stroke and the blade 24, 26 remains in the water further behind the user, when compared to a straight-shafted paddle. The sliding of the user's lower hand along the bowed shaft 30 in use, rather than along the shaft of a straight-shafted paddle, allows for greater control of the paddle assembly 11 and less wrist strain due to a reduced gripping force required.

When the paddle assembly 11 is configured to have the S-shaped shaft 34, this may provide an ergonomic shape which is comfortable for the user to grasp for prolonged periods of time, such as throughout hours of kayaking. The S-shaped 34 may also assist rotation of the shaft 34 in the user's hands during each stroke, which can decrease strain on a user's wrists than when using a straight-shafted paddle. The S-shaped shaft 34 is also usable to paddle on a SUP when standing or kneeling using the same motions as a kayak, or SUP paddle, and is ergonomic for use with one arm and hand, for example while holding another device such as a camera or fishing rod, or for users with a single arm.

In embodiments where the shaft bodies 12, 14 are partially, or substantially, resiliently deformable, the shaft bodies 12, 14 are typically deformed (flexed) during each stroke of the paddle assembly 11. When the bodies 12, 14 resiliently return to their original shape, this provides a spring effect which can accelerate driving the blade 24, 26 through the water during the stroke and/or propel the blade 24, 26 out of the water at the end of the stroke. The bow-shaped shaft 30 also allows the user to push against the shaft body 12, 14 that is further form the water with their top hand and to simultaneously pull the shaft body 12, 14 that is closer to the water, which reduces strain in the wrists compared to continuously gripping a straight-shafted paddle. The resilient deformability also allows elastic potential energy to be stored in the paddle assembly 11 in use which is released in the form of work in the direction of the user to assist with paddling as the shaft 30, 34 moves back to its original shape.

In embodiments where the paddle blade 24, 26 includes highly buoyant portions and/or structures, the buoyancy of the blades 24, 26, in combination with the bow-shaped shaft 30 or S-shaped shaft 34, may assist the user with removing the blade 24, 26 from the water at the end of the stroke as the buoyant forces move in the same operatively upward direction as the force that the user applies to remove the blade 24, 26 from the water.

In embodiments where the paddle blade 24, 25, 26, 124 is shaped to have a convex face, such as illustrated in FIGS. 8b, 8c and 9, the shape of the blade 24, 25, 26, 124 may decrease flutter and/or self-guide the paddle assembly 11 through the water in use. In embodiments where the paddle blade 26 includes oppositely curved portions, such as surfaces 96 and 98, the blade 26 may be shaped to direct water past the blade 26 in a direction perpendicular to the longitudinal axis 93 of the blade 26, i.e. in a lateral direction, in use. In embodiments where the paddle blade 25 includes oppositely curved portions, such as surfaces 123, that meet at a crest or ridge, such as the edge 116, this may further enhance flow of water across the blade 25 to substantially limit force required to be exerted by the user to move the blade 25 through the water. For both of the illustrated embodiments of the blade 25, 26, the convex shape of the face of the blade 25, 25 may enhance thrust generated by the paddle assembly 11, in use.

It will be understood that the lateral water flow caused by use of the blade 25, 26 may be laminar, i.e. the water may flow smoothly over and away from the blade 25, 26 in a lateral direction, in use, thereby increasing the fluid resistance of the water that the blade 25, 26 is being driven through. This increased fluid resistance allows for forward thrust generated by the paddle assembly 11 to increase proportionately, in use.

Referring to FIG. 9, in some embodiments, a rib height H defined by the paddle blade 25, 26 is dimensioned to be approximately one-sixth of a blade width W defined by the paddle blade 25, 26 at a cross section of the blade 25, 26 perpendicular to the longitudinal axis 93 of the paddle blade 25, 26, herein referred to as an aspect ratio of 1:6, in order to increase the prevalence of laminar water flow in the lateral direction, in use. In some embodiments, the aspect ratio of the blade 25, 26 is approximately 1:6 at all cross sections for at least half of a total length of the paddle blade 25, 26. Dimensioned the convex face of the blade 25 to be high relative to its width can substantially enhance lateral water flow away from the convex face to cause interaction with surrounding water and, as a result, can enhance thrust able to be generated by the blade 25.

In embodiments where the blade 24, 25, 26, 124 includes resiliently deformable side portions, such as the wings 82, 84, 102, 104, this may store elastic potential energy which is releasable in the form of work to assist with paddling, as the wings 82, 84, 102, 104 resiliently move back to their original shape.

In embodiments where the paddle blade 24, 25, 26, 124 has the V-shaped end 68, 92, 128, this may enhance penetrating and/or gripping a ground surface, such as sand or mud, consequently assisting the user moving a vessel across the surface. With respect to the first embodiment of the paddle blade 24, the rear portion 66 may limit the depth the paddle blade 24 can sink into a ground surface, which may also enhance grip. With respect to the second embodiment of the paddle blade 26, the smooth transition between the supportive spine 106 and the wings or sides 102, 104 may enhance water flow in a lateral direction which can increase thrust of the paddle assembly 11, in use, and the rear portion 90 may limit the depth that the paddle blade 26 can sink into a ground surface. With respect to the third embodiment of the paddle blade 25, the sharp transition between the edge 116 and the substantially flat portions 118, 120 via the curved portions 112, 114 may further enhance water flow in a lateral direction which can further increase thrust of the paddle assembly 11, in use. In embodiments of the paddle blade 25, 26 with an aspect ratio of approximately 1:6, the prevalence of laminar flow of water in the lateral direction is increased, thereby increasing the thrust generated during each stroke, in use. With respect to the fourth embodiment of the paddle blade 124, the width of the flared portion 126 provides a comfortable stop for the user's hand which may improve the grip and comfort of the user, thereby reducing the prevalence of the user's hand sliding off of the shaft 30, 34 and along the paddle blade 124, in use. It will also be appreciated that one or more features or aspects from one or more of the four paddle blade embodiments 24, 25, 26, 124 may be combined to form a paddle blade not explicitly described herein.

The paddle assembly 201 is advantageous as it has a smaller footprint than straight-shafted paddles and may be used in any direction to maximise ease of use for any user skill level due to its elongate, cylindrical shape, and can be used in a similar way to ski stocks whilst in shallow water. The pair of shaft bodies 202 can be connectable in any rotational position due to the symmetry of the shaft bodies 202 and paddle blades 210. The high degree of resilient deformability of the paddle assembly 201 allows for the pair of connected shaft bodies 202 to act as a bowed shaft or an S-shaped shaft due to the applied forces in use.

The tool assembly 301 is advantageous as it has a smaller footprint than straight-shafted tools due to the releasable connectivity of the shaft bodies 302, 304. The hand tool 320 is also usable with one arm due to one end 308, 312 of the bow-shaped shaft being configured to bear against the user as an anchoring point or support during the pushing and pulling motions carried out by one arm of the user in order to use the hand tool 320, causing the tool head 318 to do work in the direction of hand movement.

Overall, the shaft assembly 10 can enhance efficiency of paddling or tool use which may allow the user to perform better for longer and to reduce the onset of fatigue.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A paddle assembly including:
a pair of shaft bodies, each shaft body extending between opposed ends, a first end of each body being releasably connectable to the first end of the other body to allow rotationally positioning the bodies relative to each other in two positions, and a second end of each shaft body carrying a paddle blade,
the shaft bodies being shaped to be connectable to each other in a first configuration to form a bow-shaped shaft, and connectable to each other in a second configuration to form an S-shaped shaft,
wherein, in the first configuration, the shaft bodies are connected to each other such that the second end of each shaft body and each paddle blade is angled towards a first notional plane extending along a side of the paddle assembly, and
wherein, in the second configuration, the shaft bodies are connected to each other such that the second end of one shaft body and the associated paddle blade is angled towards the first notional plane, and the second end of the other shaft body and the associated paddle blade is angled towards a second notional plane arranged parallel to and spaced from the first notional plane to extend along an opposed side of the paddle assembly.

2. The paddle assembly of claim 1, wherein each shaft body is shaped such that each end defines an axis, and wherein the axis of the first end is arranged non-parallel to the axis of the second end.

3. The paddle assembly of claim 2, wherein each shaft body defines at least one bend between the ends to arrange the axes at a non-zero angle to each other.

4. The paddle assembly of claim 2, wherein each shaft body defines at least one curve between the ends to arrange the axes at a non-zero angle to each other.

5. The paddle assembly of claim 2, wherein each shaft body is shaped such that the axes are arranged at an angle between about 3 and 7 degrees to each other.

6. The paddle assembly of claim 1, wherein at least a portion of each shaft body is resiliently deformable.

7. The paddle assembly of claim 1, wherein the first end of each shaft body is configured to releasably engage the other body to allow rotationally locking the bodies in the two positions.

8. The paddle assembly of claim 7, wherein the first end of one of the shaft bodies carries at least one depressible pin, and the first end of the other shaft body defines an annular array of apertures, each aperture dimensioned to receive one of the pins, wherein arranging the, or each, pin in respective apertures engages the bodies.

9. The paddle assembly of claim 1, wherein each paddle blade includes at least one of a buoyant material portion and a hollow shell.

10. The paddle assembly of claim 1, wherein each paddle blade defines a convex face arranged to be driven into the water in use.

11. The paddle assembly of claim 10, wherein each convex face includes a pair of oppositely curved portions.

12. The paddle assembly of claim 11, wherein the oppositely curved portions meet at an edge, thereby being shaped to cause water to flow past the blade in a lateral direction, in use.

13. The paddle assembly of claim 11, wherein a rib height of the paddle blade is approximately one-sixth of a blade width of the paddle blade at a cross section of the paddle blade perpendicular to a longitudinal axis of the paddle blade.

14. The paddle assembly of claim 1, wherein each paddle blade defines a substantially V-shaped end for pushing against a surface.

15. The paddle assembly of claim 14, wherein each paddle blade includes a base surface spaced from and adjacent the V-shaped end.

16. The paddle assembly of claim 1, further including a pair of gripping portions, each gripping portion shaped to be manually grasped and arranged at the second end of one of the shaft bodies.

17. The paddle assembly of claim 1, wherein each gripping portion is integrally formed with the associated paddle blade, and/or comprises a flared portion.

18. (canceled)

19. The paddle assembly of claim 1, wherein each paddle blade defines opposed sides, and wherein at least a portion of each side is resiliently deformable.

20. The paddle assembly of claim 1, wherein each paddle blade is configured to be substantially buoyant such that, in use, when the paddle assembly is positioned in a vertically upright position such that one of the paddle blades is submerged in a body of water, approximately one-third of the submerged blade is supported above the body of water.

21. The paddle assembly of claim 1, wherein an end of at least one of the shaft bodies is connectable to a handle.

22. The paddle assembly of claim 1, wherein the shaft bodies are significantly resiliently deformable such that, in use, the shaft bodies are connectable and deformable in the first configuration to form the bow-shaped shaft, and connectable and deformable in the second configuration to form the S-shaped shaft.
